(19) United States
(12) Patent Application Publication
(10) Pub. No.: US 2011/0087907 A1
(43) Pub. Date: Apr. 14, 2011

(54) POWER SAVING METHOD AND APPARATUS

(76) Inventors: Iiro Kristian Jantunen, Helsinki (FI); Jarmo Tapani Arponen, Espoo (FI)

(21) Appl. No.: 12/995,345

(22) PCT Filed: Jun. 25, 2008
(86) PCT No.: PCT/FI2008/050387

§ 371 Date: Nov. 30, 2010

(51) Int. Cl. G06F 1/32

(52) U.S. Cl. 713/320

(57) ABSTRACT

A method and an apparatus for enabling battery power saving in an associated device is disclosed. Said battery saving is enabled by receiving electromagnetic energy carried by a wireless signal, obtaining operating power from the received electromagnetic energy, receiving a data unit over a wireless link, storing the data unit in a memory, and providing the data unit from the memory in response to a memory read request received via an input/output controller.

### FIELD OF THE INVENTION

The present invention relates in general to power saving and in particularly, though not exclusively, to saving an associated device's battery power.

### BACKGROUND OF THE INVENTION

Battery-powered electronic devices, such as mobile phones, have become commonplace in accessing the internet and other data communication networks, such as company intranets. The increase in usage of mobile devices for e.g. internet access can be attributed to e.g. introduction of new and useful applications to mobile devices and increased communications speeds through implementation of new communication technologies, such as Universal Mobile Telecommunications System (UMTS) and Wireless Local Area Networks (WLAN), in mobile devices.

Extensive usage of mobile devices for data communication means, that the wireless connection from the mobile device to a mobile communication network or to a WLAN base station is active for long periods of time, which consumes a large share of the mobile device's power resources, typically batteries. Thus, a user may have to recharge the mobile device battery inconveniently often, and a battery charger may no always be available when needed.

A user has always the possibility of reducing the amount of mobile device usage for e.g. internet access, but this may not be what many users would do if they are given a free choice. In situations like waiting for a transport at a bus terminal or at an airport many users may find it convenient to take the opportunity to read e-mails or read news from internet news services during the waiting time. Having an active wireless network connection during the whole waiting time may drain a battery of an electronic device.

### SUMMARY

The present invention aims at avoiding or mitigating problems related to prior art or at least providing a new alternative.

According to a first aspect of the invention there is provided a method comprising receiving via a first wireless link electromagnetic energy carried by a wireless signal; obtaining operating power from the received electromagnetic energy; receiving a data unit over a second wireless link that is separate from the first wireless link; storing the data unit in a memory; and providing the data unit from the memory in response to a memory read request received via an input/output controller.

According to a second aspect of the invention there is provided an apparatus comprising a power unit configured to receive via a first wireless link electromagnetic energy carried by a wireless signal and to obtain operating power for the apparatus from the received electromagnetic energy; a communication unit configured to operate a communication connection over a second wireless link that is separate from the first wireless link; an input/output controller; a memory; and a processor configured to:
receive a data unit from a peer apparatus via the second wireless link;
store the data unit in the memory; and to
provide the data unit from memory through the input/output controller in response to a memory read request received through the input/output controller.

According to a third aspect of the invention there is provided a method comprising transmitting electromagnetic energy over a first wireless link; receiving a data unit through an input/output controller; storing the data unit in a memory; and providing the data unit via a second wireless link that is separate from the first wireless link.

According to a fourth aspect of the invention there is provided an apparatus comprising a transmitter configured to transmit electromagnetic energy to a peer apparatus over a first wireless link; a communication unit configured to operate a communication connection over a second wireless link that is separate from the first wireless link; an input/output controller; a memory; and a processor configured to:
receive a data unit through the input/output controller;
store the data unit in the memory; and to
provide the data unit from the memory to the peer apparatus via the second wireless link.

According to a fifth aspect of the invention there is provided a computer program embodied in a computer readable memory medium configured to cause an apparatus on executing the program to perform: receiving via a first wireless link electromagnetic energy carried by a wireless signal; obtaining operating power from the received electromagnetic energy; receiving a data unit over a second wireless link that is separate from the first wireless link; storing the data unit in a memory; and providing the data unit from the memory in response to a memory read request received via an input/output controller.

According to a sixth aspect of the invention there is provided a computer program embodied in a computer readable memory medium configured to cause an apparatus on executing the program to perform: transmitting electromagnetic energy over a first wireless link; receiving a data unit through an input/output controller; storing the data unit in a memory; and providing the data unit via a second wireless link.

According to a seventh aspect of the invention there is provided an apparatus comprising: means for receiving via a first wireless link electromagnetic energy carried by a wireless signal and to obtain operating power for the apparatus from the received electromagnetic energy; means for operating a communication connection over a second wireless link that is separate from the first wireless link; means for controlling an input/output; means for storing data; and means for processing data configured to:
receive a data unit from a peer apparatus via the second wireless link;
store the data unit in the means for storing data; and to
provide the data unit from memory through the means for controlling input/output in response to a memory read request received through the means for controlling input/output.

According to a eighth aspect of the invention there is provided an apparatus comprising: means for transmitting electromagnetic energy to a peer apparatus over a first wireless link; means for operating a communication connection over a second wireless link; means for controlling an input/output; means for storing data; and means for processing data configured to:
receive a data unit through the means for controlling input/output;
store the data unit in the means for storing data; and to
provide the data unit from the means for storing data to the peer apparatus via the second wireless link.

Various exemplary embodiments of the present invention are illustrated hereinafter in the detailed description of the invention as well as in the dependent claims appended hereto. The embodiments are illustrated with reference to selected aspects of the invention. A person skilled in the art appreciates that any embodiment of the invention may apply to other aspects as well either alone or in combination with other embodiments.

### BRIEF DESCRIPTION OF THE DRAWINGS

The invention will be described, by way of example only, with reference to the accompanying drawings, in which:

FIG. 1 shows a schematic picture of a system in which at least one embodiment of the invention may be used;

FIG. 2 outlines an example structure of an apparatus according to an embodiment of the invention;

FIG. 3 shows an example of protocol stacks according to an embodiment of the invention.

FIG. 4 shows an example of a method according to an embodiment of the invention.

### DETAILED DESCRIPTION

In the following description, like numbers denote like elements.

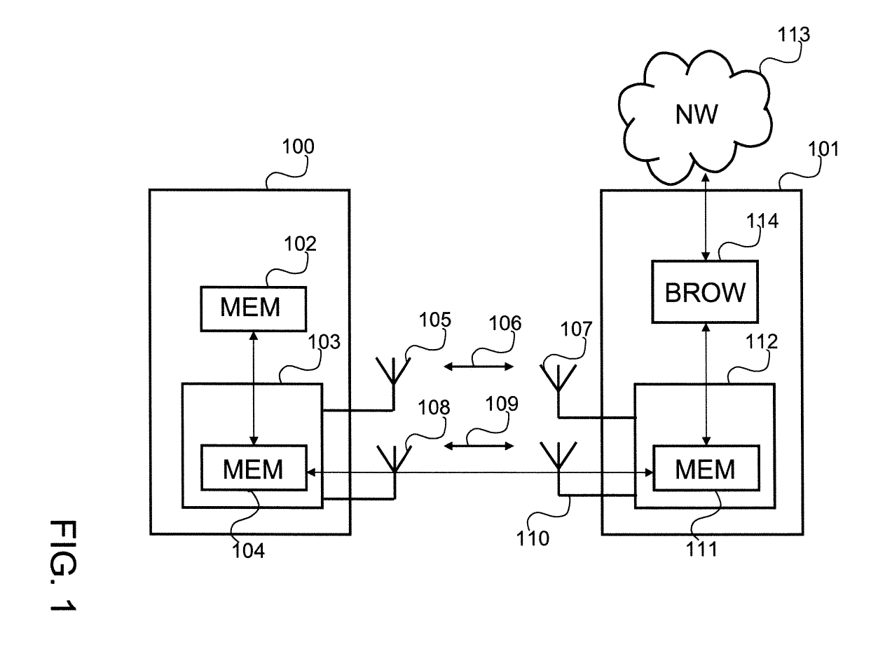

Reference is now made to FIG. 1, which depicts an example system, where at least one embodiment of the invention may be used. The example system of FIG. 1 comprises two devices 100, 101 and a network 113.

According to at least one embodiment of the invention, the first device 100 may be e.g. a portable or mobile device, such as a laptop computer, handheld computer, Personal Digital Assistant (PDA), or a mobile phone. According to at least one embodiment, the second device 101 may be e.g. a server computer. In at least one embodiment, the network 113 may be e.g. a TCP/IP based communication network, such as the internet or a company's intranet. The second device 101 may be connected to the network 113 by means of a wired or wireless connection or a combination thereof.

The first device 100 may comprise a memory 102, which may be a volatile or a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a memory or smart card, such as a SIM or USIM card, or the like. The device 100 may comprise a plurality of memories 102. The memory 102 may be constructed as a part of the device 100 or it may be inserted into a slot, port, or the like of the device 100, or connected to a port of the device 100 via a cable, such as a Universal Serial Bus (USB) cable. The memory 102 may serve the sole purpose of storing data, or it may be constructed as a part of an apparatus serving other purposes, such as processing data.

The first device 100 may further comprise a communication apparatus 103. The communication apparatus 103 of FIG. 1 may comprise a memory 104 and antennas 105 and 108.

The second device 101 may comprise a browser module 114 and a communication apparatus 112. The communication apparatus 112 of FIG. 1 may comprise a memory 111 and antennas 107 and 110. The communication apparatuses 103 and 112 may be in a peer association via wireless links 106 and 109 in a manner described in further detail hereinafter.

In at least one embodiment of the invention, the communication apparatuses 103, 112 may comprise only one antenna each. For example, the communication apparatus 103 may comprise the antenna 108, and the communication apparatus 112 may comprise the antenna 110. In case a peer association between the communication apparatuses requires two wireless links between the communication apparatuses, other antennas of the devices 100, 101 (not shown in FIG. 1) may be used. Then, signals that are directed to the communication apparatuses 103, 112 and be carried over a wireless link between the other antennas of the devices 100, 101 may be passed to the communication apparatuses 103, 112 internally from the respective radio circuitries of the devices 100, 101.

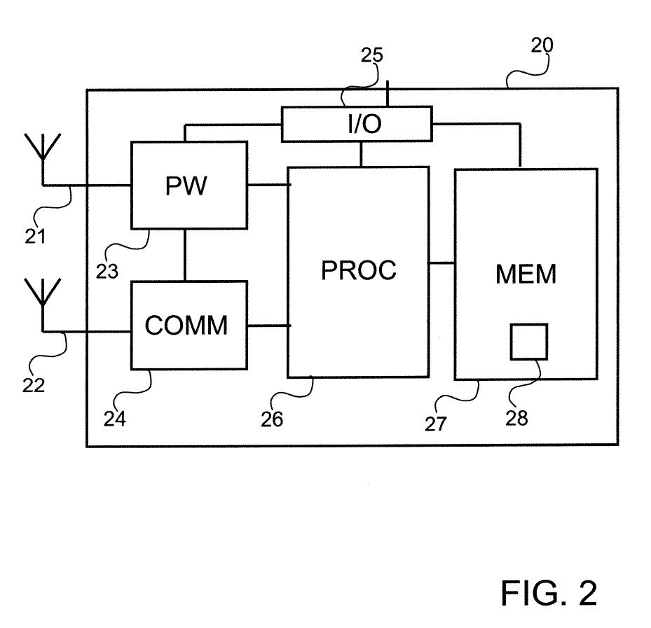

Reference is now made to FIG. 2, which depicts an exemplary structure of a communication apparatus according to at least one embodiment. The communication apparatus 20 of FIG. 2 may comprise an antenna 21, 22, a power unit 23, a communication unit 24, an input/output controller 25, a processor 26, and a memory 27. The communication apparatus 20 may also comprise a computer program 28 stored in the memory 27 and operable to be executed on the processor 26.

The power unit 23 may comprise circuitry, including e.g. coils, capacitors, and rectifiers, that receives electromagnetic energy e.g. in the form of an electromagnetic signal via antenna 21 and obtains operating power for the communication apparatus 20 from the electromagnetic signal.

In embodiments where the communication apparatus 20 comprises only one antenna, for example antenna 22, the power unit may be operatively coupled to a radio circuitry external to the communication apparatus 20 and receive an electromagnetic signal from the external radio circuitry via said coupling.

The communication unit 24 may comprise a transmitter portion that is configured to transmit signals over a wireless connection via antenna 22, and a receiver portion that is configured to receive signals over the wireless connection via the antenna 22. The communication unit may further comprise other circuitry, such as microcontroller(s), filter(s), and digital-analogue converters.

The input/output controller 25 may comprise circuitry that provides an interface between the communication apparatus 20 and external apparatuses, devices etc. The input/output controller 25 may receive data and/or instructions from the processor 26 via an internal bus or serial line, and data and/or instructions from an external apparatus or device via a system bus, serial line or the like.

The processor 26 may be e.g. a microprocessor. The processor 26 is configured to control the operation of the communication apparatus 20 according to program code instructions of the computer program 28, when the program code instructions are executed on the processor 28.

The memory 27 may be configured to store computer programs, program code instructions, and data under the control of the processor 26. The memory 27 may be a volatile or a non-volatile memory, such as a read-only memory (ROM), a programmable read-only memory (PROM), erasable programmable read-only memory (EPROM), a random-access memory (RAM), a flash memory, or a phase change memory (PCM). The communication apparatus 20 may comprise a plurality of memories 27. The memory 27 may be constructed as a part of the communication apparatus 20. The memory 27 may serve the sole purpose of storing data, or it may be constructed as a part of e.g. the processor 26.

According to at least one embodiment, the communication apparatus 20 may be implemented e.g. as an embedded portion of a device, such as a desktop computer, deskside computer, server computer, laptop computer, handheld computer, Personal Digital Assistant (PDA), or a mobile phone.

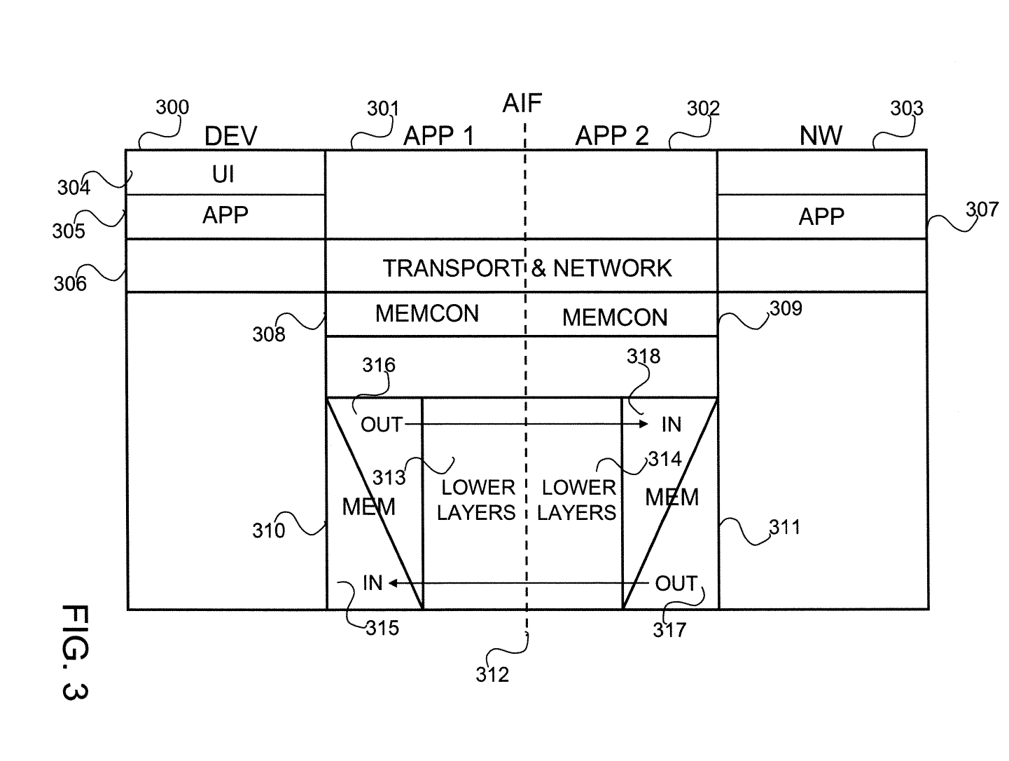

Reference is now made to FIG. 3, which shows an outline of example protocol stacks according to an embodiment of the invention. FIG. 3 shows a protocol stack 300 for a device, such as the first device 101 or the second device 102 mentioned hereinbefore with reference to FIG. 1, a protocol stack 301 for a first communication apparatus, a protocol stack 302 for a second communication apparatus, and a protocol stack 303 for a content providing server residing e.g. in the internet or in a company's intranet.

The device protocol stack 300 may comprise a user interface layer 304, an application layer 305 (e.g. a HyperText Transmission Protocol HTTP layer, as shown in FIG. 3), and transport and network layers (such as TCP and IP layers) 306 (shown as a single layer). The transport and network layer provides an end-to-end connection between the connection endpoints. FIG. 3 also shows the application layer 307 of the content provider server protocol stack 303.

FIG. 3 further shows peer communication apparatuses APP 1, APP 2 that communicate by means of respective protocol stacks 301, 302 over an air interface 312. Each of the protocol stacks 301, 302 may comprise a memory control layer 308, 309 and lower protocol layers 313, 314. The lower protocol layers may comprise a network layer, a media access control (MAC) layer, and a physical layer (not shown in FIG. 3).

The peer communication apparatuses represented by the protocol stacks 301, 302 may further comprise memories 310, 311 that may comprise memory portions 315, 318 configured to receive data and memory portions 316, 317 configured to send data. The memory portions 316, 317 may be operatively coupled to the memory portions 315, 318 by means of a wireless link established over the air interface 312.

The memories 310, 311 may be accessed from outside the peer communication apparatuses by means of the memory control layers 308, 309 in a manner described further hereinafter. For example, the communication apparatus APP1 may access the memory 311 of the communication apparatus APP 2 using an interface provided by the memory control layers 308, 309.

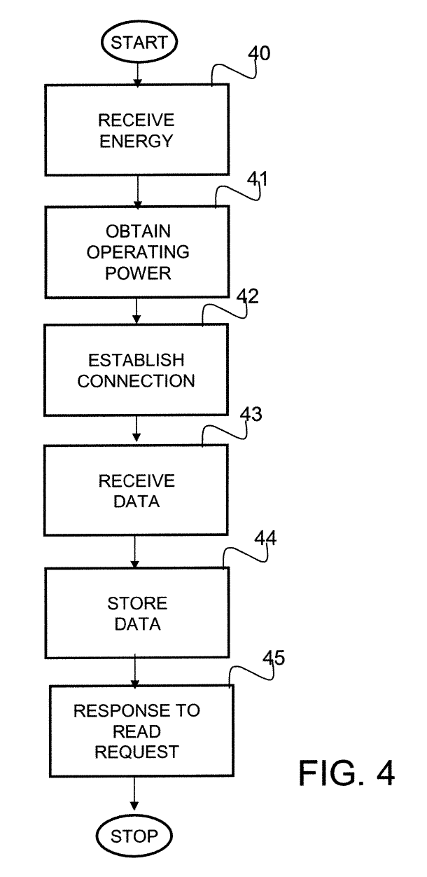

Reference is now made to FIG. 4, which shows an example of a method according to an embodiment of the invention. In step 40, electromagnetic energy is received. The electromagnetic energy may be received in the form of a signal, such as an ultra high frequency or near-field communication signal, carried over a wireless link. The signal carrying the electromagnetic energy may be received e.g. by the power unit 23 of the communication apparatus 20 of FIG. 2 via the antenna 21 or via a coupling to an external radio circuitry in a manner described hereinbefore.

In step 41, operating power is obtained from the received electromagnetic energy. As in step 40, the operating power may be obtained e.g. by the power unit 23 of the communication apparatus 20 of FIG. 2. The power unit 20 may then supply the operating power to the other structural parts of the communication apparatus 20.

In step 42, a connection may be established between peer communication apparatuses, such as those described e.g. with reference to FIG. 3. The connection may be established over a wireless link using ultra wideband (UWB) impulse radio (IR) technology. The connection establishment may comprise e.g. synchronization of bit streams as well as authentication and/or authorization procedures, such as verification of access control credentials.

In step 43, data may be received over the connection established in step 42. The data may be received in the form of data units, such as Internet Protocol (IP) packets. The data may be received e.g. by the receiver portion of the communication unit 24 of the communication apparatus 20 of FIG. 2.

In step 44, the received data may be stored in a memory. With reference to FIG. 2, the receiver portion of the communication unit 24 may pass the received data on to the processor 26, which then may store the data into the memory 27.

In step 45 of FIG. 4, the received data is retrieved from the memory and sent to a requesting party as a response to a memory read request. The memory read request may be received e.g. by the processor 26 via the input/output controller 25. The memory read request may be made using a command interface provided by e.g. the memory control layer 308, 309 of FIG. 3. The memory control layer 308, 309 along with the rest of the layers of the protocol stack 301, 302 of FIG. 3 may be effected in the communication apparatus 20 of FIG. 2 e.g. by means of the computer program 28.

With reference to FIG. 1, the memory read request may originate e.g. from the device 100. As a response to the memory read request, the received data may be transferred from the communication apparatus memory 104 to the device memory 102.

The method of FIG. 4 may further comprise the step of receiving data via an input/output controller, such as the input/output controller 25 of FIG. 2. The received data may originate e.g. from an application running on a device, into which the communication apparatus 20 of FIG. 2 has been implemented. The received data may be stored in a memory and provided via a wireless link as a response to a memory read request.

For example, with reference to FIG. 2, processor 26 may receive data via input/output controller 25 from outside the communication apparatus 20. For example, the processor may receive data from a device memory in a manner shown in FIG. 1. The processor may store the received data in memory 27, until the processor 26 receives a memory read request from a peer communication apparatus via a wireless link. The memory read request from the peer communication apparatus may be received by antenna 22 and the receiver portion of the communication unit 24, which forwards the memory read request to the processor 26. The memory read request may be effected using a command interface provided by a memory control protocol layer shown in FIG. 3.

As a response to the memory read request, the processor 26 may retrieve the requested data from the memory 27, and send the requested data towards the requesting peer communication apparatus via the transmitter portion of the communication unit 24 and the antenna 22.

The method of FIG. 4 may further comprise receiving of program commands from a peer communication apparatus via the connection established in step 42, and providing the received commands via an input/output unit e.g. to the operating system of a device on which the communication apparatus resides. For example, a communication apparatus may receive from a peer communication apparatus program commands that may be used to launch a particular application on the device. The peer communication apparatus may initiate the sending of the program commands as a response to the communication apparatus coming to proximity close enough for establishing a connection according to step 42 of FIG. 4 to the peer communication apparatus. For example, with reference to FIG. 2, if the power unit 23 of the communication apparatus 20 receives an electromagnetic signal from the peer communication apparatus via the antenna 21 and obtains operating power for the communication apparatus from the signal, the powering-up of the communication apparatus 20 may cause the communication apparatus to initiate a connection establishment according to step 42 of FIG. 4.

As an illustrative example, the communication apparatus may receive from the peer apparatus program commands that cause the operating system of the device on which the communication apparatus resides to launch a web browser. In addition, the communication apparatus may receive parameters associated with the program commands, such as Uniform Resource Locators (URL) of web pages. The communication apparatus may also receive data that may be processed in the application. For example, the communication apparatus may receive the content of a web page that can be displayed in a web browser.

Various embodiments of the invention are now described by way of illustrative examples with references to FIGS. 1 to 4. The device 100 of FIG. 1 may be for example a mobile phone equipped with a web browser application. When the device 100 is brought to proximity of a second device 101, peer communication apparatuses 103, 112 are capable of establishing a connection with each other.

Suppose that the communication apparatus 112 of the second device 101 receives its operating power from the device 101. In this scenario, when the communication apparatus 103 is brought into close proximity of the communication apparatus 112, the communication apparatus 103 may receive an electromagnetic signal 106 from the communication apparatus 112 via the antenna 105 such that the communication apparatus 103 may obtain its operating power from the electromagnetic signal. In other words, the communication apparatus 112 may operate as a power source for the communication apparatus 103, and the communication apparatus 103 may not need to use e.g. the battery of the device 100 as a power source. The electromagnetic signal 106 may be e.g. an ultra high frequency signal. As described hereinbefore, the communication apparatus may also receive the electromagnetic signal or power contained by the electromagnetic signal through an operative coupling to the radio circuitry of the device 100. In this case, the electromagnetic signal or power from the electromagnetic signal is received through an antenna of the device 100 (not shown in FIG. 1).

When the communication apparatus 103 has sufficient operating power for communication, a connection between the communication apparatuses 103, 112 may be established over a wireless link 109. For example, ultra wideband impulse radio technology may be used.

In response to the connection establishment between the communication apparatuses 103, 112, the communication apparatus may send program commands to the communication apparatus 103 via the wireless link 109. With reference to FIG. 3, the communication apparatus 112 may use the interface provided by the memory control protocol layer to input the program commands into the memory 104 of the communication apparatus 103. In a similar manner, the communication apparatus 112 may input parameters associated with the program commands into the memory 104.

The communication apparatus 112 may send the program commands to the communication apparatus 103 for the purpose of launching a particular application on the device 100. In this case the communication apparatus 103 may pass the program commands on to the operating systems of the device 100. For example, with reference also to FIG. 2, the processor 26 of the communication apparatus 20 (corresponds to the communication apparatus 103 of FIG. 1) may receive the program commands via the communication unit 24 and input the program commands into the memory 102 of the device 100 of FIG. 1 via the input/output unit 25 shown in FIG. 2.

The communication apparatus 112 may also send data content that is to be processed by the application to the device 100 via the communication apparatus 103 using the wireless link 109 in a similar manner.

For example, if the device 100 of FIG. 1 comprises a web browser, the web browser application may be launched when the device 100 is brought into close proximity of the second device 101. More precisely, the web browser application may be launched when the communication apparatus 103 is brought into close proximity with the peer communication apparatus 112. In response to the communication apparatus 103 being in close proximity, the communication apparatus 112 supplies the communication apparatus 103 with operating power and causes the web application to start on the device 100 in a manner described hereinbefore.

Referring further to FIG. 1, an application running on the device 100 may send program commands to an application 114 running on the second device 101 according to at least one embodiment of the invention. As an illustrative example, a web browser running on the device 100 may send commands to a browser engine 114 running on the device 101.

As opposed to a traditional approach, where a web browser of the device 100 would use the means, such as an Application Programming Interfaces, provided by the operating system and/or protocol stacks of the device 100 to establish a connection to e.g. a content providing server residing on the internet, the web browser of the device 100 may use the connection between the communication apparatuses 103, 112 for the purpose of sending browsing commands to the browser engine of the second device 101.

With reference also to FIG. 3, the web browser running on the device 100 of FIG. 1 may access the memory 104 of the communication apparatus 103 using the command interface provided by the memory control layer 308 shown in FIG. 3. In other words, by means of the memory control layer 308, the web browser may write the browsing commands into the memory 104 of the communication apparatus 103, for example into the portion 316 of the memory 310 shown in FIG. 3.

The communication apparatus 104 of FIG. 1 may then access the memory 111 of the communication apparatus 112 over the wireless link 109 using the command interface provided by the memory control layers 308, 309 shown in FIG. 3, and write the browsing commands into the memory 111 of the second device 101, for example into the portion 318 shown in FIG. 311.

The browsing commands may the be delivered from the memory 111 of the communication apparatus 112 to the browser engine 114. For example, the browser engine may access the memory 111 using the command interface provided by the memory control protocol layer 309 shown in FIG. 3 and read the browsing commands from the memory 111.

The browser engine 114 may establish a connection to a web server residing e.g. on the internet and retrieve content from the web server according to the browsing commands received from the web browser of the device 100. Once the browser engine 114 has received the requested content, it may send the content to the web browser of the device 100.

According to an embodiment, the browser engine 114 may use the command interface of the memory control layer 309 show in FIG. 3 to access the memory 111 of the communication apparatus 112 and write the retrieved content into the memory 111. The communication apparatus 112 may then use the command interface of the memory control layers 308, 309 for writing the retrieved content into the memory 104 of the communication apparatus 103. The web browser of the device 100 may then read the retrieved content from the memory 104 of the communication apparatus using the command interface provided by the memory control layer 308 shown in FIG. 3.

In one embodiment of the invention, the first device 100 is configured to indicate to the second device 101 one or more content selection criteria for use by the second device to select content that is desired by a user of the first device 100 and/or supported by the hardware and software capabilities of the first device. The indicating of the one or more content selection criteria may be based on providing the criteria on establishing a communication session with the second device 101. Alternatively, the second device 101 may be configured to entirely or partly obtain the criteria based on an identifier associated with the first device 100 or a user of the first device 100 so that the criteria need not at least entirely be transmitted from the first device to the second device each time the first and second device establish a communication session.

The content selection criteria may be buffered by the second device 101 or by a network entity accessible to the second device, e.g. by a proxy server that is aware of hardware and/or software configuration of the first device 100. It is appreciated that the communication session between the first device 100 and the second device 101 may be too short for retrieving the criteria over network from a remote entity and thus obtaining the criteria directly from the first device by the second device may be advantageous especially in case that the range of the wireless links between the first device 100 and the second device 101 is short in comparison to the speed at which the two devices may move in relation to each other.

The content selection criteria may comprise e.g. one or more of user preferences regarding content size; type; content classification such mother tongue of the user; age of the content and/or whether the content may comprise bad language, indecent material or violent material; capabilities of the first device e.g. video support; video streaming support; audio support; audio streaming support; estimated delay of starting a streaming session; available memory; processor type; display size; display type; and digital rights management data associated with the first device 100.

As described hereinbefore, at least some embodiments of the invention may enable retrieval of content from the internet without establishing a connection to the internet via e.g. mobile telecommunication network or a wireless local area network using a mobile phone's radio resources that consume the mobile phone's battery energy. Said retrieval may be enabled by utilizing a communication apparatus residing on the mobile phone. The communication apparatus obtains its operating power from e.g. a peer communication apparatus and handles the content retrieval in a manner described herein. Therefore, a need of using the mobile phone's battery power may be eliminated.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A method comprising:
receiving via a first wireless link electromagnetic energy carried by a wireless signal;
obtaining operating power from the received electromagnetic energy;
receiving a data unit over a second wireless link that is separate from the first wireless link, wherein the second wireless link is an impulse radio link;
storing the data unit in a memory; and
providing the data unit from the memory in response to a memory read request received via an input/output controller.

2. A method according to claim 1, further comprising:
receiving a second data unit via the input/output controller;
storing the second data unit in the memory; and
providing the second data unit from the memory in response to a second memory read request received via the second wireless link.

3. A method according to claim 1, further comprising:
receiving program commands via the second wireless link; and
providing the program commands via the input/output controller.

4. (canceled)

5. (canceled)

6. A method according to claim 3, further comprising:
receiving parameters associated with the program commands via the second wireless link; and
providing the parameters via the input/output controller.

7. A method according to claim 3, wherein the program commands are provided to cause an application to launch and wherein the method further comprises:
receiving application data to be processed by the application via the second wireless link; and
providing the application data via the input/output controller.

8. An apparatus comprising:
a power unit configured to receive via a first wireless link electromagnetic energy carried by a wireless signal and to obtain operating power for the apparatus from the received electromagnetic energy;
a communication unit configured to operate a communication connection over a second wireless link that is separate from the first wireless link, wherein the second wireless link is an impulse radio link;
an input/output controller;
a memory; and
a processor configured to:
receive a data unit from a peer apparatus via the second wireless link;
store the data unit in the memory; and to
provide the data unit from memory through the input/output controller in response to a memory read request received through the input/output controller.

9. An apparatus according to claim 8, wherein the processor is further configured to:
receive a second data unit through the input/output controller;
store the second data unit in the memory; and to
provide the second data unit from the memory through the communication unit in response to a second memory read request received through the communication unit.

10. An apparatus according to claim 8, wherein the data units carry application data.

11. (canceled)

12. (canceled)

13. (canceled)

14. An apparatus according to claim 8, wherein the first wireless link is an ultra high frequency or a near field communication link and the second wireless link is a ultra wideband link.

15. An apparatus according to claim 8, wherein the processor is further configured to:
receive program commands through the communication unit; and to provide the program commands through the input/output controller.

16. An apparatus according to claim 15, wherein the processor is further configured to:
receive parameters associated with the program commands through the communication unit; and to
provide the parameters through the input/output controller.

17. An apparatus according to claim 15, wherein the processor is further configured to:
launch an application responsive to the received program commands;
receive application data to be processed by the application through the communication unit; and to provide the application data through the input/output controller.

18. An apparatus according to claim 8, wherein the apparatus is further configured to indicate to the peer apparatus one or more content selection criteria for content to be received via the second wireless link.

19. A method comprising:
transmitting electromagnetic energy over a first wireless link;
receiving a data unit through an input/output controller;
storing the data unit in a memory; and
providing the data unit via a second wireless link, wherein the second wireless link is an impulse radio link.

20. A method according to claim 19, further comprising:
receiving a second data unit via the second wireless link;
storing the second data unit in the memory; and
providing the second data unit via the input/output controller.

21. A method according to claim 19, further comprising:
sending program commands via the second wireless link.

22. An apparatus comprising:
a transmitter configured to transmit electromagnetic energy to a peer apparatus over a first wireless link;
a communication unit configured to operate a communication connection over a second wireless link, wherein the second wireless link is an impulse radio link;
an input/output controller;
a memory; and
a processor configured to:
receive a data unit through the input/output controller;
store the data unit in the memory; and to provide the data unit from the memory to the peer apparatus via the second wireless link.

23. An apparatus according to claim 22, wherein the processor is further configured to:
receive a second data unit from a peer apparatus via the second wireless link;
store the second data unit in the memory; and to
provide the second data unit via the input/output controller.

24. An apparatus according to claim 22, wherein the processor is further configured to send program commands to the peer apparatus via the second wireless link.

25. (canceled)

26. A computer program embodied in a computer readable memory medium configured to cause an apparatus on executing the program to perform:
receiving via a first wireless link electromagnetic energy carried by a wireless signal;
obtaining operating power from the received electromagnetic energy;
receiving a data unit over a second wireless link that is separate from the first wireless link, wherein the second wireless link is an impulse radio link;
storing the data unit in a memory; and
providing the data unit from the memory in response to a memory read request received via an input/output controller.

27. (canceled)

28. (canceled)
